(19) United States
(12) Patent Application Publication
(10) Pub. No.: US 2025/0353966 A1
(43) Pub. Date: Nov. 20, 2025

(54) LIQUID SILICONE RUBBER COMPOSITION

(71) Applicant: DOW SILICONES CORPORATION, Midland, MI (US)

(72) Inventor: Michael BACKER, Wiesbaden (DE)

(21) Appl. No.: 18/995,695

(22) PCT Filed: Jul. 10, 2023
(86) PCT No.: PCT/US2023/027199

§ 371 Date: Jan. 16, 2025

Related U.S. Application Data
(60) Provisional application No. 63/389,970, filed on Jul. 18, 2022.

(51) Int. Cl. C08G 77/20; C08G 77/08; C08G 77/12; C08K 5/37; C08K 9/06

(52) U.S. Cl. CPC C08G 77/20; C08G 77/08; C08G 77/12; C08K 5/37; C08K 9/06

(57) ABSTRACT

The present disclosure relates to hydrosilylation (addition) curable silicone rubber compositions, which upon cure provide silicone elastomeric materials with improved low compression set whilst avoiding the need to undertake a post-curing step and to a method for preparing said silicone elastomeric materials. The present disclosure also extends to uses for such materials in or for the manufacture of silicone coatings for standard non-silicone insulators, as cable coatings e.g., for safety cables, in cable accessories such as electrical connectors, connector seals, terminations and wire seals, and for other electrical and electronic parts, particularly for the automotive industry

The present disclosure relates to hydrosilylation (addition) curable silicone rubber compositions, which upon cure provide silicone elastomeric materials with improved low compression set whilst avoiding the need to undertake a post-curing step and to a method for preparing said silicone elastomeric materials. The present disclosure also extends to uses for such materials in or for the manufacture of silicone coatings for standard non-silicone insulators, as cable coatings e.g., for safety cables, in cable accessories such as electrical connectors, connector seals, terminations and wire seals, and for other electrical and electronic parts, particularly for the automotive industry and/or in or as hoses and gaskets for e.g., vehicle engines.

Hydrosilylation curable silicone rubber compositions containing
(i) organopolysiloxane polymers having unsaturated (alkenyl and/or alkynyl) groups;
(ii) compounds containing silicon-bonded hydrogen atoms; and
(iii) a hydrosilylation catalyst
   are known in the art and are used to prepare silicone elastomeric materials with a broad spectrum of physical properties including electrical insulation, resistance and stability to heat, freeze resistance, abrasion resistance, fire retardancy, and long-term flexibility. This unique combination of properties renders elastomers made from liquid silicone rubber suitable for utilisation in a wide range of electrical and/or insulative applications, such as those described above, many of which require silicone elastomeric materials to have a low compression set in addition to their electrical insulation and/or heat stability etc. applications. For example, automotive vehicles are increasingly dependent on electrical and electronical systems for the full operation thereof, even more so since the introduction of electric and hybrid vehicles. Hence, electrical failures can lead to devices malfunctioning such as radio, light, ventilation etc. or even breakdown. Many of the electrical connectors rely on the aforementioned silicone rubber materials to prevent electrical failings and they need to be able to avoid failure at increasing engine temperatures.

Compression set is a key property of silicone elastomeric materials utilized in any of the above applications. Compression set is a thermally induced fatigue behavior of a silicone elastomeric material which may be defined as the loss in ability of said silicone elastomeric material to recover to its original thickness after compression for specific period of time at a set (elevated) temperature. A compression set value may be measured, for example, following the industrial standard ISO 815-1:2019 methods A, B or C and is identified as a percentage, such that if there is complete recovery, i.e., if the thickness of a test specimen is identical before and after the application of a load, the compression set is 0%; if, in contrast, a 25% compression of a silicone elastomeric material applied during a test remains unchanged when the load is removed, the compression set is 100% because it has failed to return to its original shape at all. Without being tied to current theories, it is believed is believed that the root cause of the inability of a silicone-based elastomeric material to recover to its original thickness after compression over a specified period of time at a set (elevated) temperature is that hydrosilylation curable silicone compositions often, if not always, do not undergo complete cure during the standard curing process. This is thought to, at least partially, be because of incomplete hydrosilylation due to steric hindrance during interaction of vinyl containing silicone polymers, Si—H cross-linker(s) and hydrosilylation catalysts (most typically platinum based catalysts. Thus, when a hydrosilylation cured silicone elastomeric material is compressed at an elevated temperature, further cross-linking may occur within the body of the silicone elastomeric material specifically at previously unreacted Si—H positions. Additionally, inter-molecular bond formation can occur between polydimethylsiloxane (PDMS) chains, again particularly at previously unreacted Si—H excess positions (via hydrolysis, oxidative or thermally induced reaction pathways), and thermal, oxidative, and thermo-oxidative rearrangements may occur within or between individual PDMS chains of the silicone elastomeric material. The occurrence of one or more of the above will cause an increase in crosslink density within the silicone elastomeric material and consequently a more rigid structure which prevents the silicone elastomeric material to return to its original thickness after compression.

Many silicone elastomeric materials have a substantial compression set e.g., of greater than 50% or even greater than 60% even after compression at temperatures of 125° C. and 150° C. for short periods of time each 22 hours and can suffer from problems caused by a consequential change in shape and/or a significant increase in hardness during long-term service in high-temperature applications unless they undergo a post-cure heating process. “Post cure” is the most straightforward way to minimise compression set where hydrosilylation-cured silicone materials are subjected to a period of several hours e.g., four or more hours of post-cure heating at temperature of 150° C. or greater. However, post-cure is not usually commercially desired or indeed viable given increasing energy consumption and delays in manufacture time.

Many applications described above typically desire silicone elastomeric materials having a compression set value which is as low as possible e.g., no greater than 40%, alternatively preferably no greater than 20% after being subjected to compression across a wide spectrum of temperatures e.g., from −40° C. to +175° C., or even higher.

In the United States electrical connector systems have to meet the requirements of the SAE International USCAR-2 “Performance Specification for Automotive Electrical Connector Systems” testing regime. Sealed connector assemblies are graded for their suitability for use over specified temperature ranges T1 temperature class is for the temperature range −40° C. to +85° C.; T2 is for the temperature range −40° C. to +100° C.; T3 is for the temperature range −40° C. to +125° C.; fulfilling the T3 temperature class of relevant automotive specs for a temperature range of −40° C. to 125° C.; T4 is for the temperature range −40° C. to +150° C.; and currently the highest grade is T5 for the temperature range −40° C. to 175° C. Given it is not desirable to be forced to post cure every elastomer after cure a variety of additives have been proposed for the reduction of compression set without the need for post-cuing. In U.S. Pat. No. 5,153,244 compression set values of hydrosilylation cured silicone were substantially reduced by the introduction into said compositions of a phthalocyanine compound or a metal derivative of such a compound, where the metal was copper, nickel, cobalt or iron.

U.S. Pat. No. 8,080,598 identified a hydrosilylation cured silicone rubber which has low compression set without post curing using a metal deactivator selected from a diacyl-hydrazide-based compound such as dodecanedioyl-di-(N′-salicyloyl) hydrazine, a synonym for which is 1-N′,12-N′-bis(2-hydroxybenzoyl)dodecanedihydrazide, an aminotriazole-based compound such as 3-(n-salicyloyl)amino-1,2,4-triazole, a synonym for which is 2-hydroxy-N-1H-1,2,4-triazol-3-ylbenzamide, or an amino-containing triazine-based compound in combination with a cure inhibitor selected from an acetylene-containing silane, a vinyl-containing low-molecular-weight organosiloxane compound, or an alcohol derivative having carbon-carbon triple bonds to reduce compression set. EP0517524 and U.S. Pat. No. 5,104,919 describe the use of different triazole and benzotriazole derivatives as additives for the controlled reduction of the compression set of hydrosilylation cured silicone elastomers. U.S. Pat. No. 5,977,249 describe the use of a variety of organic sulfur compounds, especially mercaptans and U.S. Pat. No. 9,200,146 describes the use of 3-amino-1,2,4-triazole-5-thiol, bonded to silica for reducing compression set.

There is provided herein a hydrosilylation curable silicone rubber composition, which comprises the following components:
a) one or more polyorganosiloxanes containing at least two unsaturated groups, selected from alkenyl groups and alkynyl groups, per molecule and having a viscosity in a range of from 1000 mPa.s to 100,000 mPa.s at 25° C.;
b) an organosilicon compound having at least two, alternatively at least three Si—H groups per molecule;
c) a silica reinforcing filler which is optionally hydrophobically treated;
d) a hydrosilylation catalyst comprising or consisting of a platinum group metal or a compound thereof;
e) at least one thio-propionate selected from

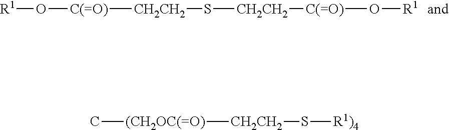

Where each R¹ may be the same or different and is an alkyl group, wherein the total wt. % of the composition is 100 wt. %.

There is also provided a silicone elastomeric material which is the cured product of the above hydrosilylation curable silicone rubber composition, which silicone elastomeric material has a compression set of no more than 20% after 22 hours compression at temperatures up to 190° C. measured in accordance with industrial standard norm ISO 815-1:2019 method A.

There is also provided a process for making a silicone elastomeric material comprising the steps of mixing a hydrosilylation curable silicone rubber composition having the following components:
a) one or more polyorganosiloxanes containing at least two unsaturated groups, selected from alkenyl groups and alkynyl groups, per molecule and having a viscosity in a range of from 1000 mPa.s to 100,000 mPa.s at 25° C.;
b) an organosilicon compound having at least two, alternatively at least three Si—H groups per—molecule;
c) a silica reinforcing filler which is optionally hydrophobically treated;
d) a hydrosilylation catalyst comprising or consisting of a platinum group metal or a compound thereof;
e) at least one thio-propionate selected from

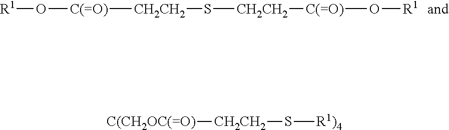

Where each R¹ may be the same or different and is an alkyl group; wherein the total wt. % of the composition is 100 wt. %;
and curing the composition at a temperature of from 80° C. to 200° C.

There is also provided a silicone elastomeric material obtained or obtainable from a process comprising the steps of mixing a hydrosilylation curable silicone rubber composition having the following components:
a) one or more polyorganosiloxanes containing at least two unsaturated groups, selected from alkenyl groups and alkynyl groups, per molecule and having a viscosity in a range of from 1000 mPa.s to 100,000 mPa.s at 25° C.;
b) an organosilicon compound having at least two, alternatively at least three Si—H groups per molecule;
c) a silica reinforcing filler which is optionally hydrophobically treated;
d) a hydrosilylation catalyst comprising or consisting of a platinum group metal or a compound thereof;
e) at least one thio-propionate selected from

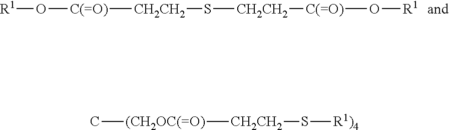

Where each R¹ may be the same or different and is an alkyl group; wherein the total wt. % of the composition is 100 wt. %;
And curing the composition at a temperature of from 80° C. to 200° C.;
which silicone elastomeric material has a compression set of no more than 20% after 22 hours compression at temperatures up to 190° C. when measured in accordance with industrial standard norm ISO 815-1:2019 method A.

There is also provided the use of at least one thio-propionate selected from

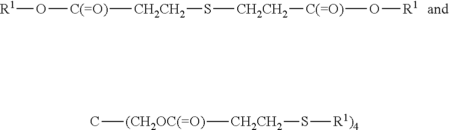

Where each R¹ may be the same or different and is an alkyl group; as a means of reducing the compression set in a silicone elastomeric material which is the cured product of a hydrosilylation curable silicone rubber composition, which otherwise comprises the following components:
a) one or more polyorganosiloxanes containing at least two unsaturated groups, selected from alkenyl groups and alkynyl groups, per molecule and having a viscosity in a range of from 1000 mPa.s to 100,000 mPa.s at 25° C.;

b) an organosilicon compound having at least two, alternatively at least three Si—H groups per molecule;

c) a silica reinforcing filler which is optionally hydrophobically treated;

d) a hydrosilylation catalyst comprising or consisting of a platinum group metal or a compound thereof;
wherein the total wt. % of the composition is 100 wt. %.

It was found that compositions as described herein containing component (e) upon provided a silicone elastomer with a consistently improved (lower) compression across a broad temperature range of from 100° C. to about 190° C. compared to two of the most preferred commercially used compression set additives, namely the aforementioned dodecanedioyl-di-(N′-salicyloyl)hydrazine, a synonym for which is 1-N′, 12-N′-bis(2-hydroxybenzoyl)dodecanedihydrazide, and 3-(n-Salicyloyl)Amino-1,2,4-Triazole, a synonym for which is 2-Hydroxy-N-1H-1,2,4-triazol-3-ylbenzamide. A further added advantage resulting from the use of compositions containing component (e) as a compression set additive over many earlier sulphur containing compression set additives is that component (e) is not malodorous whereas other previously proposed sulphur containing compression set additives cause the resulting silicone elastomer to have a sulphurous odour which was not appreciated in industry.

The components of the composition are hereafter described in further detail.

### Component (a)

Component (a) of the composition is one or more polyorganosiloxanes containing at least two unsaturated groups, selected from alkenyl groups and alkynyl groups, per molecule and having a viscosity in a range of from 1000 mPa.s to 100,000 mPa.s at 25° C.

Component (a) is a polyorganosiloxane such as a polydiorganosiloxane having at least two unsaturated groups per molecule, which unsaturated groups are selected from alkenyl or alkynyl groups. Alternatively, component (a) has at least three unsaturated groups per molecule.

The unsaturated groups of component (a) may be terminal, pendent, or in both locations.

Alkenyl groups may have 2 to 30, alternatively 2 to 24, alternatively 2 to 20, alternatively 2 to 12, alternatively 2 to 10, and alternatively 2 to 6 carbon atoms. Possible alkenyl groups are exemplified by, but not limited to, vinyl, allyl, methallyl, propenyl, and hexenyl and cyclohexenyl groups.

Alkynyl groups may have 2 to 30, alternatively 2 to 24, alternatively 2 to 20, alternatively 2 to 12, alternatively 2 to 10, and alternatively 2 to 6 carbon atoms. Alkynyl groups may be exemplified by, but not limited to, ethynyl, propynyl, and butynyl groups.

Component (a) has multiple units of the formula (I):

R′ₐSiO_{(4-a)/2} (I)

in which each R′ is independently selected from an aliphatic hydrocarbyl, or aliphatic non-halogenated organyl group (that is any aliphatic organic substituent group, regardless of functional type, having one free valence at a carbon atom). Saturated aliphatic hydrocarbyls are exemplified by, but not limited to alkyl groups such as methyl, ethyl, propyl, pentyl, octyl, undecyl, and octadecyl and cycloalkyl groups such as cyclohexyl. Unsaturated aliphatic hydrocarbyls are exemplified by, but not limited to the alkenyl groups and alkynyl groups described above. The aliphatic non-halogenated organyl groups are exemplified by, but not limited to, suitable nitrogen containing groups such as amido groups, imido groups; oxygen containing groups such as polyoxyalkylene groups, carbonyl groups, alkoxy groups and hydroxyl groups. Further organyl groups may include phosphorus containing groups, boron containing groups. The subscript “a” is 0, 1, 2 or 3, typically in this instance a is mainly 2 but may contain some units where a is 1 or 3.

Siloxy units may be described by a shorthand (abbreviated) nomenclature, namely—“M,” “D,” “T,” and “Q”, when R′ is as described above, alternatively an alkyl group, typically a methyl group The M unit corresponds to a siloxy unit where a=3, that is R′₃SiO_{1/2}; the D unit corresponds to a siloxy unit where a=2, namely R′₂SiO_{2/2}; the T unit corresponds to a siloxy unit where a =1, namely R′₁SiO_{3/2}; the Q unit corresponds to a siloxy unit where a =0, namely SiO_{4/2}. The polyorganosiloxane, such as a polydiorganosiloxane of component (a), is substantially linear but may contain a proportion of branching due to the presence of T units (as previously described) within the molecule, hence the average value of subscript a in structure (I) is about 2.

Examples of typical R′ groups on component (a) the one or more polyorganosiloxanes containing at least two unsaturated groups, selected from alkenyl groups and alkynyl groups, per molecule, include mainly alkyl groups, especially methyl and ethyl, alternatively methyl groups but may also include aryl groups and/or fluoroalkyl groups such as trifluoropropyl or perfluoroalkyl groups in addition to the required at least two unsaturated groups selected from alkenyl and/or alkynyl groups, typically alkenyl groups The groups may be in pendent position (on a D or T siloxy unit) or may be terminal (on an M siloxy unit).

Hence, the polymer chain of component (a) may be selected from polydimethylsiloxanes, alkylmethylpolysiloxanes, alkylarylpolysiloxanes or copolymers thereof (where reference to alkyl means any suitable alkyl group, alternatively an alkyl group having two or more carbons) providing each component (a) polymer comprises at least two alkenyl and or alkynyl groups, typically at least two alkenyl groups. Such polymer chains may have any suitable terminal groups, for example, they may be trialkyl terminated, alkenyldialkyl terminated alkynyldialkyl terminated or may be terminated with any other suitable terminal group combination providing each polymer contains at least two unsaturated groups selected from alkenyl and alkynyl groups per molecule. In one embodiment the terminal groups of such a polymer don't comprise any silanol terminal groups.

Hence component (a) may, for the sake of example, be:
a dialkylalkenyl terminated polydimethylsiloxane, e.g., dimethylvinyl terminated polydimethylsiloxane; a dialkylalkenyl terminated dimethylmethylphenylsiloxane, e.g., dimethylvinyl terminated dimethylmethylphenylsiloxane; a trialkyl terminated dimethylmethylvinyl polysiloxane; a dialkylvinyl terminated dimethylmethylvinyl polysiloxane copolymer; a dialkylvinyl terminated methylphenylpolysiloxane, a dialkylalkenyl terminated methylvinylmethylphenylsiloxanc; a dialkylalkenyl terminated methylvinyldiphenylsiloxane; a dialkylalkenyl terminated methylvinyl methylphenyl dimethylsiloxane; a trimethyl terminated methylvinyl methylphenylsiloxane; a trimethyl terminated methylvinyl diphenylsiloxane; or a trimethyl terminated methylvinyl methylphenyl dimethylsiloxane.

Component a) has a viscosity of from 1000 mPa.s to 100,000 mPa.s at 25° C., alternatively 5000 mPa.s to 75,000 mPa.s at 25° C., 10,000 mPa.s to 60,000 mPa.s at 25° C. and is preferably present in an amount of from 25 to 60 wt. % of the composition, alternatively in an amount of from 30 to 60 wt. % of the composition, alternatively in an amount of from 35 to 55 wt. % of the composition. Viscosity may be measured at 25° C. using either a Brookfield™M rotational viscometer with spindle LV-4 for viscosities over 15,000 mPa.s (Spindle LV-4 designed for viscosities in the range between 1,000-2,000,000 mPa.s) at an appropriate rpm and using a Brookfield™ rotational viscometer with a cone plate arrangement with cone CP-52 for viscosities up to 15, 000 mPa.s at 25° C. and an appropriate rpm.

### Component (b)

Component (b) functions as a cross-linker and is provided in the form of an organosilicon compound having at least two, alternatively at least three Si—H groups per molecule. Component (b) normally contains three or more silicon-bonded hydrogen atoms so that the hydrogen atoms can react with the unsaturated alkenyl and/or alkynyl groups of component (a) to form a network structure therewith and thereby cure the composition. Some or all of Component (b) may alternatively have two silicon bonded hydrogen atoms per molecule when polymer (a) has greater than two unsaturated groups per molecule.

The molecular configuration of the organosilicon compound having at least two, alternatively at least three Si—H groups per molecule (b) is not specifically restricted. It may be a polyorganosiloxane which can have a straight chain, be branched (a straight chain with some branching through the presence of T groups), cyclic or be a silicone resin based.

While the molecular weight of component (b) is not specifically restricted, the viscosity is typically from 5 to 50,000 mPa.s at 25° C. using the test methodology as described for component (a). Silicon-bonded organic groups used in component (b) may be exemplified by alkyl groups such as methyl, ethyl, propyl, n-butyl, t-butyl, pentyl, hexyl; aryl groups such as phenyl tolyl, xylyl, or similar aryl groups; 3-chloropropyl, 3,3,3-trifluoropropyl, or similar halogenated alkyl group, preferred alkyl groups having from 1 to 6 carbons, especially methyl ethyl or propyl groups or phenyl groups. Preferably the silicon-bonded organic groups used in component (b) are alkyl groups, alternatively methyl, ethyl or propyl groups.

Examples of the organosilicon compound having at least two, alternatively at least three Si—H groups per molecule (b) include but are not limited to:
(a′) trimethylsiloxy-terminated methylhydrogenpolysiloxane,
(b′) trimethylsiloxy-terminated polydimethylsiloxanc-methylhydrogensiloxanc,
(c′) dimethylhydrogensiloxy-terminated dimethylsiloxane-methylhydrogensiloxane copolymers,
(d′) dimethylsiloxane-methylhydrogensiloxane cyclic copolymers,
(e′) copolymers and/or silicon resins consisting of (CH₃)₂HSiO_{1/2} units, (CH₃)₃SiO_{1/2} units and SiO_{4/2} units,
(f′) copolymers and/or silicone resins consisting of (CH₃)₂HSiO_{1/2} units and SiO_{4/2} units,
(g′) Methylhydrogensiloxane cyclic homopolymers having between 3 and 10 silicon atoms per molecule;
alternatively, component (b), the cross-linker, may be a filler, e.g., silica treated with one of the above, and mixtures thereof.

In one embodiment the Component (b) is selected from a methylhydrogenpolysiloxane capped at both molecular terminals with trimethylsiloxy groups; a copolymer of a methylhydrogensiloxane and a dimethylsiloxane capped at both molecular terminals with trimethylsiloxy groups; dimethylsiloxane capped at both molecular terminals with dimethylhydrogensiloxy groups; a copolymer of a methylhydrogensiloxane and a dimethylsiloxane capped at both molecular terminals with dimethylhydrogensiloxy groups.

The cross-linker (b) is generally present in the hydrosilylation curable silicone rubber composition such that the molar ratio of the total number of the silicon-bonded hydrogen atoms in component (b) to the total number of alkenyl and/or alkynyl groups in component (a) is from 0.5:1 to 10:1. When this ratio is less than 0.5:1, a well-cured composition will not be obtained. When the ratio exceeds 10:1, there is a tendency for the hardness of the cured composition to increase when heated. Preferably component (b) is in an amount such that the molar ratio of silicon-bonded hydrogen atoms of component (b) to alkenyl/alkynyl groups, alternatively alkenyl groups of component (a) ranges from 0.7:1.0 to 5.0:1.0, alternatively from 0.9:1.0 to 2.5:1.0, and further alternatively from 0.9:1.0 to 2.0:1.0.

The silicon-bonded hydrogen (Si—H) content of component (b) is determined using quantitative infra-red analysis in accordance with ASTM E168. In the present instance the silicon-bonded hydrogen to alkenyl (vinyl) and/or alkynyl ratio is important when relying on a hydrosilylation cure process. Generally, this is determined by calculating the total weight % of alkenyl groups in the composition, e.g., vinyl [V] and the total weight % of silicon bonded hydrogen [H] in the composition and given the molecular weight of hydrogen is 1 and of vinyl is 27 the molar ratio of silicon bonded hydrogen to vinyl is 27[H]/[V].

Typically, dependent on the number of unsaturated groups in component (a) as well as the number of Si—H groups in component (b), component (b) will be present in an amount of from 0.1 to 10 wt. % of the hydrosilylation curable silicone rubber composition, alternatively 0.1 to 7.5wt. % of the hydrosilylation curable silicone rubber composition, alternatively 0.5 to 7.5wt. %, further alternatively from 0.5% to 5 wt. % of the hydrosilylation curable silicone rubber composition.

### Component (c)

Component (c) is a silica reinforcing filler which is optionally hydrophobically treated; The reinforcing fillers of component (c) may be exemplified by fumed silica and/or a precipitated silica and/or a colloidal silica. In one alternative, the fumed silica, precipitated silica and/or colloidal silica are provided in a finely divided form.

Precipitated silica, fumed silica and/or colloidal silicas are particularly preferred because of their relatively high surface area, especially when provided in a finely divided form, which is typically at least 50 m²/g (BET method in accordance with ISO 9277:2010). Fillers having surface areas of from 50 to 450 m²/g (BET method in accordance with ISO 9277:2010), alternatively of from 50 to 300 m²/g (BET method in accordance with ISO 9277:2010), are typically used. All these types of silica are commercially available.

When silica reinforcing filler (c) is naturally hydrophilic (e.g., untreated silica fillers), it is typically treated with a treating agent to render it hydrophobic. These surface modified silica reinforcing fillers (c) do not clump and can be homogeneously incorporated into polydiorganosiloxane polymer (a), described below, as the surface treatment makes the fillers easily wetted by component (a).

Typically, silica reinforcing filler (c) may be surface treated with any low molecular weight organosilicon compounds disclosed in the art applicable to prevent creping of liquid silicone rubber (LSR) compositions during processing. For example, organosilanes, polydiorganosiloxanes, or organosilazanes e.g., hexaalkyl disilazane, short chain siloxane diols to render the silica reinforcing filler (c) (s) hydrophobic and therefore easier to handle and obtain a homogeneous mixture with the other ingredients. Specific examples include, but are not restricted to, silanol terminated trifluoropropylmethylsiloxane, silanol terminated vinyl methyl (ViMe) siloxane, silanol terminated methyl phenyl (MePh) siloxane, liquid hydroxyldimethyl-terminated polydiorganosiloxane containing an average from 2 to 20 repeating units of diorganosiloxane in each molecule, hydroxyldimethyl terminated Phenylmethyl Siloxane, hexaorganodisiloxanes, such as hexamethyldisiloxane, divinyltetramethyldisiloxane; hexaorganodisilazanes, such as hexamethyldisilazane (HMDZ), divinyltetramethyldisilazane and tetramethyldi (trifluoropropyl) disilazane; hydroxyldimethyl terminated polydimethylmethylvinyl siloxane, octamethyl cyclotetrasiloxane, and silanes including but not limited to methyltrimethoxysilane, dimethyldimethoxysilane, vinyltrimethoxysilane, methyltriethoxysilane, vinyltriethoxysilane, chlrotrimethyl silane, dichlrodimethyl silane, trichloromethyl silane.

In one embodiment, the treating agent may be selected from silanol terminated vinyl methyl (ViMe) siloxane, liquid hydroxyldimethyl-terminated polydiorganosiloxane containing an average from 2 to 20 repeating units of diorganosiloxane in each molecule, hexaorganodisiloxanes, such as hexamethyldisiloxane, divinyltctramethyldisiloxane; hexaorganodisilazanes, such as hexamethyldisilazane (HMDZ), divinyltetramethyldisilazane and; hydroxyldimethyl terminated polydimethylmethylvinyl siloxane, octamethyl cyclotetrasiloxane, and silanes including but not limited to methyltriethoxysilane, dimethyldiethoxysilane and/or vinyltriethoxysilane. A small amount of water can be added together with the silica treating agent(s) as processing aid.

The surface treatment of untreated silica reinforcing filler (c) may be undertaken prior to introduction in the composition or in situ (i.e., in the presence of at least a portion of the other ingredients of the composition herein by blending these ingredients together at room temperature or above until the filler is completely treated. Typically, untreated silica reinforcing filler (c) is treated in situ with a treating agent in the presence of component (a) which results in the preparation of a silicone rubber base material which can subsequently be mixed with other ingredients.

Silica reinforcing filler (c) is optionally present in an amount of up to 40 wt. % of the composition, alternatively from 1.0 to 40wt. % of the composition, alternatively of from 5.0 to 35wt. % of the composition, alternatively of from 10.0 to 35wt. % of the composition.

### Component (d)

Component (d) of the composition is a hydrosilylation catalyst comprising or consisting of a platinum group metal or a compound thereof. These are usually selected from catalysts of the platinum group of metals (platinum, ruthenium, osmium, rhodium, iridium and palladium), or a compound of one or more of such metals. Alternatively, platinum and rhodium compounds are preferred due to the high activity level of these catalysts in hydrosilylation reactions, with platinum compounds most preferred. In a hydrosilylation (or addition) reaction a hydrosilylation catalyst such as component (d) herein catalyses the reaction between an unsaturated group, usually an alkenyl group e.g., vinyl with Si—H groups.

The catalyst (d) can be a platinum group metal, a platinum group metal deposited on a carrier, such as activated carbon, metal oxides, such as aluminum oxide or silicon dioxide, silica gel or powdered charcoal, or a compound or complex of a platinum group metal. Preferably the platinum group metal is platinum.

Examples of preferred hydrosilylation catalysts (d) are platinum based catalysts, for example, platinum black, platinum oxide (Adams catalyst), platinum on various solid supports, chloroplatinic acids, e.g., hexachloroplatinic acid (Pt oxidation state IV) (Speier catalyst), chloroplatinic acid in solutions of alcohols e.g., isooctanol or amyl alcohol (Lamoreaux catalyst), and complexes of chloroplatinic acid with ethylenically unsaturated compounds such as olefins and organosiloxanes containing ethylenically unsaturated silicon-bonded hydrocarbon groups, e.g., tetra-vinyl-tetramethylcyclotetrasiloxane-platinum complex (Ashby catalyst). Soluble platinum compounds that can be used include, for example, the platinum-olefin complexes of the formulae (PtCl₂. (olefin)₂ and H (PtCl₃.olefin), preference being given in this context to the use of alkenes having 2 to 8 carbon atoms, such as cthylene, propylene, isomers of butene and of octene, or cycloalkanes having 5 to 7 carbon atoms, such as cyclopentene, cyclohexene, and cycloheptene. Other soluble platinum catalysts are, for the sake of example a platinum-cyclopropane complex of the formula (PtCl₂C₃H₆)₂, the reaction products of hexachloroplatinic acid with alcohols, ethers, and aldehydes or mixtures thereof, or the reaction product of hexachloroplatinic acid and/or its conversion products with vinyl-containing siloxanes such as methylvinylcyclotetrasiloxane in the presence of sodium bicarbonate in ethanolic solution-. Platinum catalysts with phosphorus and amine ligands can be used as well, e.g., (Ph₃P)₂PtCl₂; and complexes of platinum with vinylsiloxanes, such as sym-divinyltetramethyldisiloxane.

Hence, specific examples of suitable platinum-based catalysts include:
(i) complexes of chloroplatinic acid with organosiloxanes containing ethylenically unsaturated hydrocarbon groups are described in U.S. Pat. No. 3,419,593;
(ii) chloroplatinic acid, either in hexahydrate form or anhydrous form;
(iii) a platinum-containing catalyst which is obtained by a method comprising reacting chloroplatinic acid with an aliphatically unsaturated organosilicon compound, such as divinyltetramethyldisiloxane;
(iv) alkene-platinum-silyl complexes as described in US Pat. No. 6,605,734 such as (COD)Pt(SiMeCl₂)₂ where “COD” is 1,5-cyclooctadiene; and/or
(v) Karstedt's catalyst, a platinum divinyl tetramethyl disiloxane complex typically containing about 1 wt. % of platinum typically in a vinyl siloxane polymer with a viscosity of from about 200 to 750 using the test methodology as described for component (a).

Solvents such as toluene and the like organic solvents have been used historically as alternatives but the use of vinyl siloxane polymers by far the preferred choice. These are described in U.S. Pat. Nos. 3,715,334 and 3,814,730. In one preferred embodiment component (d) may be selected from co-ordination compounds of platinum. In one embodiment hexachloroplatinic acid and its conversion products with vinyl-containing siloxanes, Karstedt's catalysts and Speier catalysts are preferred. Component (d) is typically present in a quantity of platinum atom that provides from 0.1 to 500 ppm (parts per million) with respect to the weight of the reactive ingredients, components (a) and (b). The catalyst may be added as a single species or as a mixture of two or more different species. Typically, dependent on the form/concentration in which the catalyst is provided the amount of catalyst present will be within the range of from 0.05-1.5 wt. % of the composition, alternatively from 0.05-1.0 wt. %, alternatively from 0.1-1.0 wt. %, alternatively 0.1 to 0.5 wt. %, of the composition, wherein the platinum catalyst is provided in a masterbatch of polymer such as (a) described above.

### Component (e)

Component (e) of the hydrosilylation curable silicone rubber composition is at least one thio-propionate selected from

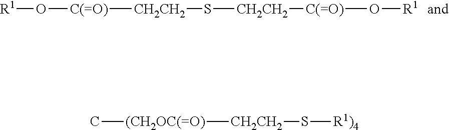

Where each R¹ may be the same or different and is an alkyl group. Each R¹ alkyl group may be linear, branched and or may contain a cyclic alkyl group and may comprise from 1 to 25 carbons, alternatively each R¹ has from 5 to 25 carbons, alternatively each R¹ has from 10 to 25 carbons, alternatively each R¹ is a linear alkyl group having from 10 to 25 carbons such as a decyl group, an undecyl group, a dodecyl group, a tridecyl group, a tetradecyl group, a pentadecyl group a hexadecyl group, a heptadecyl group, an octadecyl group, a nonadecyl group or an eiconsane group. In one embodiment all R¹ groups in a compound of component (e) contain the same number of carbons, i.e., is the same. A small amount (less than 5 wt. %, alternatively less than 2 wt. %) of branching may be present in such groups. Specific examples of component (e) include for the sake of example but are not restricted to

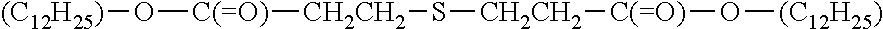

Didodecyl 3,3′-thiodipropionate;

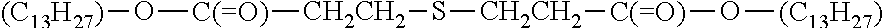

Di(tridecyl) 3,3′-thiodipropionate;

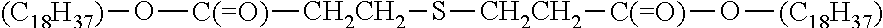

Dioctadecyl 3,3′-thiodipropionate; and

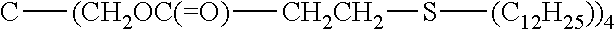

pentaerythritol-tetrakis-(3-dodecyl-thio-propionate)

Component (e) the thio-propionate as described above may be present in the composition in an amount of from 0.025 to 0.5 wt. % of the composition, alternatively from 0.05 to 0.35 wt. %, alternatively from 0.075 to 0.35 wt. %, alternatively from 0.075 to 0.25 wt. %, alternatively from 0.075 to 0.20 wt. %.

### Optional Additives

Such hydrosilylation curable silicone rubber compositions may also comprise one or more optional additives depending on the intended use. Examples include cure inhibitors, mold releasing agents, adhesion catalysts, peroxides, electrically conductive fillers, thermally conductive fillers, pot life extenders, flame retardants, lubricants, heat stabilisers, UV light stabilizers, bactericides, wetting agents and the like.

### Cure Inhibitors

Cure inhibitors are used, when required, to prevent or delay the addition-reaction curing process especially during storage. The optional addition-reaction inhibitors of platinum-based catalysts are well known in the art and include hydrazines, triazoles, phosphines, mercaptans, organic nitrogen compounds, acetylenic alcohols, silylated acetylenic alcohols, maleates, fumarates, ethylenically or aromatically unsaturated amides, cthylenically unsaturated isocyanates, olcfinic siloxanes, unsaturated hydrocarbon monoesters and diesters, conjugated ene-ynes, hydroperoxides, nitriles, and diaziridines. Alkenyl-substituted siloxanes as described in U.S. Pat. No. 3,989,667 may be used, of which cyclic methylvinylsiloxanes are preferred.

One class of known hydrosilylation reaction inhibitors are the acetylenic compounds disclosed in U.S. Pat. No. 3,445,420. Acetylenic alcohols such as 2-methyl-3-butyn-2-ol constitute a preferred class of inhibitors that will suppress the activity of a platinum-containing catalyst at 25° C. Compositions containing these inhibitors typically require heating at temperature of 70° C. or above to cure at a practical rate.

Examples of acetylenic alcohols and their derivatives include 1-ethynyl-1-cyclohexanol (ETCH), 2-methyl-3-butyn-2-ol, 3-butyn-1-ol, 3-butyn-2-ol, propargyl alcohol, 1-phenyl-2-propyn-1-ol, 3,5-dimethyl-1-hexyn-3-ol, 1-ethynylcyclopentanol, 3-methyl-1-penten-4-yn-3-ol, and mixtures thereof.

Derivatives of acetylenic alcohol may include those compounds having at least one silicon atom. When present, inhibitor concentrations as low as 1 mole of inhibitor per mole of the metal of catalyst will in some instances impart satisfactory storage stability and cure rate. In other instances, inhibitor concentrations of up to 500 moles of inhibitor per mole of the metal of catalyst are required. The optimum concentration for a given inhibitor in a given composition is readily determined by routine experimentation. Dependent on the concentration and form in which the inhibitor selected is provided/available commercially, when present in the composition, the inhibitor is typically present in an amount of from 0.0125 to 10% by weight of the composition. In one embodiment the inhibitor when present is selected from 1-ethynyl-1-cyclohexanol (ETCH) and/or 2-methyl-3-butyn-2-ol and is present in an amount of greater than zero to 0.1% by weight of the composition.

### Mold Release Agent

Any suitable mold release agent may be utilised. It may, for example, be a hydroxydimethyl terminated polydimethylsiloxane having viscosity of approximately 21 mPa.s at 25° C. measured using a Brookfield™ rotational viscometer with spindle LV-2 at 12 rpm.

### Flame Retardants

Examples of flame retardants include aluminium trihydrate, chlorinated paraffins, hexabromocyclododecane, Melamine cyanurate, melamine polyphosphate, ammonium polyphosphate triphenyl phosphate, dimethyl methylphosphonate, tris(2,3-dibromopropyl) phosphate (brominated tris), and mixtures or derivatives thereof. When present in the composition, flame retardants are typically present in an amount of from 0.1 to 5% by weight of the composition.

### Lubricants

Examples of lubricants include tetrafluoroethylene, resin powder, graphite, fluorinated graphite, talc, boron nitride, fluorine oil, silicone oil, molybdenum disulfide, trimethylsilyl terminated phenylmethylsiloxane dimethylsiloxane copolymers having a viscosity of from 100 mPa.s to 200 mPa.s at 25° C. using the viscosity test methodology as described for component (a) and mixtures or derivatives thereof.

### Heat Stabilisers

The composition herein may also comprise one or more inorganic heat stabilizers, such as hydrated cerium oxide, cerium hydroxide, cerium carboxylates and/or cerium esters, e.g., cerium ethylhexanoate, hydrated aluminum oxide, red iron oxide, yellow iron oxide, carbon black, graphite and zinc oxide used alone or in combination.

Hence, in one alternative, the present disclosure thus provides a hydrosilylation curable silicone rubber composition, which comprises any suitable combination of the following components:
a) one or more polyorganosiloxanes containing at least two unsaturated groups, selected from alkenyl groups and alkynyl groups, per molecule and having a viscosity in a range of from 1000 mPa.s to 100,000 mPa.s at 25° C.; alternatively 5000 mPa.s to 75,000 mPa.s at 25° C., 10,000 mPa.s to 60,000 mPa.s at 25° C., an is preferably present in an amount of from 25 to 60 wt. % of the composition, alternatively in an amount of from 30 to 60 wt. % of the composition, alternatively in an amount of from 35 to 55 wt. % of the composition. Viscosity may be measured at 25° C. as described above.
b) an organosilicon compound having at least two, alternatively at least three Si—H groups per molecule, which may be present in an amount of from 0.1 to 10 wt. % of the silicone rubber composition, alternatively 0.1 to 7.5wt. % of the hydrosilylation curable silicone rubber composition, alternatively 0.5 to 7.5wt. %, further alternatively from 0.5% to 5 wt. % of the composition;
c) a silica reinforcing filler which is preferably in a finely divided form and is optionally hydrophobically treated; high surface area, which is typically at least 50 m²/g (BET method in accordance with ISO 9277:2010). Silica reinforcing filler (c) s having surface areas of from 50 to 450 m²/g (BET method in accordance with ISO 9277:2010), alternatively of from 50 to 300 m²/g (BET method in accordance with ISO 9277:2010) and are typically present in an amount of up to 40 wt. % of the composition, alternatively from 1.0 to 40wt. % of the composition, alternatively of from 5.0 to 35wt. % of the composition, alternatively of from 10.0 to 35wt. % of the composition;
d) a hydrosilylation catalyst comprising or consisting of a platinum group metal or a compound thereof; in an amount dependent on the form/concentration in which the catalyst is provided, within the range of from 0.001 to 3.0 wt. % of the composition, alternatively from 0.001 to 1.5 wt. % of the composition, alternatively from 0.01-1.5 wt. %, alternatively 0.01 to 0.1.0 wt. %, of the silicone rubber composition,
e) at least one thio-propionate selected from

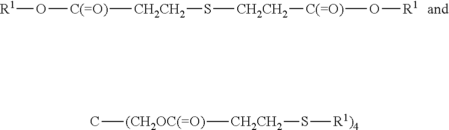

Where each R¹ may be the same or different and is an alkyl group. Each R¹ alkyl group may be linear, branched and or may contain a cyclic alkyl group and may comprise from 1 to 25 carbons, alternatively each R¹ has from 5 to 25 carbons, alternatively each R¹ has from 10 to 25 carbons, alternatively each R¹ is a linear alkyl group having from 10 to 25 carbons such as a decyl group, an undecyl group, a dodecyl group, a tridecyl group, a tetradecyl group, a pentadecyl group a hexadecyl group, a heptadecyl group, an octadecyl group, a nonadecyl group or an eiconsane group.

Component (e) is present in the composition in an amount of from 0.025 to 0.5 wt. % of the composition, alternatively from 0.05 to 0.35 wt. %, alternatively from 0.075 to 0.35 wt. %, alternatively from 0.075 to 0.25 wt. %, alternatively from 0.075 to 0.20 wt. %. providing the total wt. % of the composition is 100 wt. %.

The composition may also contain one or more of the above optional additives in amounts indicated again providing the total wt. % of the composition is 100 wt. %.

The hydrosilylation curable silicone rubber compositions described above are usually stored before use in two or more parts. In the case of a two-part composition, the two parts are usually referred to as part (A) and part (B):
Part (A) typically contains the catalyst (d) in addition to polyorganosiloxane (a) and silica reinforcing filler (c) when present, and
Part (B) usually includes cross-linker component (b), and when present optional inhibitor as well as remaining polyorganosiloxane (a) and/or the silica reinforcing filler (c).

It is important for the catalyst (d) to be stored separately from cross-linker (b) to prevent premature cure during storage.

Components (e), the at least one thio-propionate, may be stored in either part (A) or part (B) or in both parts providing they do not negatively affect the storage of any of the essential ingredients present in the respective part. Alternatively, if desired component (e) may be added into the remaining composition i.e., to the combination of the part (A) and part (B) compositions during or after the part (A) composition and the part (B) compositions are mixed together prior to use. Any optional additives, other than the inhibitor described above, may be incorporated into either part (A) or part (B) or in both parts providing they do not negatively affect the storage of any of the essential ingredients present in the respective part.

Ingredients/components in each of Part (A) and/or Part (B) may be mixed together individually in their respective part or may be introduced into the composition in pre-prepared in combinations for, e.g., ease of mixing the final composition. For Example, components (a) and (c) are often mixed together to form an LSR polymer base or masterbatch prior to introduction of other ingredients. These may then be mixed with the other ingredients of the Part being made directly or may be used to make pre-prepared concentrates commonly referred to in the industry as masterbatches. In this instance, for ease of mixing ingredients, one or more masterbatches may be utilized to successfully mix the ingredients to form Part (A) and/or Part (B) compositions. For example, a “fumed silica” masterbatch may be prepared. This is effectively an LSR silicone rubber base with the silica reinforcing filler (c) treated in situ.

Parts A and B of the composition may be prepared by combining all of their respective components at ambient temperature. Any mixing techniques and devices described in the prior art can be used for this purpose. The particular device to be used will be determined by the viscosities of components and the final composition. A suitable mixer may include but are not limited to kneader mixer, a static mixer in a liquid injection molding machine, a Z-blade mixer, a two-roll mill (open mill), a three-roll mill, a Haake® Rheomix OS Lab mixer, a screw extruder or a twin-screw extruder or the like. Speed mixers as sold by e.g., Hauschild and as DC 150.1 FV, DAC 400 FVZ or DAC 600 FVZ, may alternatively be used. Cooling of components during mixing may be desirable to avoid premature curing of the composition.

The part (A) and part (B) compositions can be designed to be mixed in any suitable weight ratio e.g., part (A): part (B) may be mixed together in weight ratios of from 10:1 to 1:10, alternatively from 5:1 to 1:5, alternatively from 2:1 to 1:2, but most preferred is a weight ratio of 1:1.

Prior to use the respective Part (A) and Part (B) compositions are mixed together in the desired weight ratio.

Curing of the hydrosilylation curable silicone rubber composition on the substrate can, for example, take place in a mold to form a molded part, by injection molding, using e.g., a Liquid injection molding system (LIMS) press moulding, extrusion moulding, transfer moulding, press vulcanization, or calendaring. The compression set test pieces may be molded into suitable shapes e.g., a cylindrical disc of diameter 29.0 mm±0.5 mm and thickness 12.5 mm±0.5 mm and these were compressed by 25% to about 9.38 mm thickness. These may be prepared in molds or alternatively may be cut out of a pressed sheet of the silicone elastomeric material.

Under compression the LSR buttons (cured before at 175° C. for 10 min) were kept between two metal plates in a convection oven for a suitable period of time, typically 22 hours at an elevated temperature before compression was released and the test pieces were allowed to recover to a thickness as close to the starting thickness allowing for the compression set to be determined.

The hydrosilylation curable silicone rubber composition is cured at any suitable temperature e.g., at a temperature of from 80° C. to 200° C., alternatively from about 100° C. to 180° C., alternatively from about 120° C. to 180° C. As indicated above one of the standard ways of reducing compression set historically has been post curing with a view to reducing the number curable groups which might cure under compression during use as gaskets. It has been surprisingly found that composition as herein defined do not appear to benefit from post cure processes as will be explained further below.

In the case of a process for the manufacture of a two-part silicone rubber composition as hereinbefore described the process may comprise the steps
(i) preparation of a silicone base composition comprising components (a) polymer and (c) silica reinforcing filler,
(ii) dividing the resulting base into two parts, part (A) and part (B) and introducing the catalyst (d) into part (A) and the cross-linker (b) and inhibitor (if present) in the part (B) composition.
(iii) Introducing the other components any other optional additives into either or both part (A) and part (B); and
(iv) Storing the part (A) and part (B) compositions separately.

Typically, when utilised the part (A) and part (B) compositions are thoroughly mixed in a suitable weight ratio as described above, immediately before use in order to avoid premature cure. The curing stage cure is then undertaken. The low compression set silicone elastomer compositions and methods herein are useful for applications such as acting as a barrier to prevent absorption or penetration of air, dust, noise, liquids, gaseous substances, or dirt. Silicone elastomeric materials with low compression set as described herein may be used in gasketing. They are also utilised in a wide range of electrical and/or insulative applications. In the case of electrical applications, for example, silicone elastomeric materials resulting from the compositions described herein may be utilised in or for both internal and external applications e.g., as silicone coatings for standard non-silicone insulators, as cable coatings e.g., for safety cables, in cable accessories such as electrical connectors, terminations and wire seals.

They may be useful in all sorts of electrical applications requiring wiring/cabling/power supply and the like. For example, in the case of automotive applications include electrical connectors, terminations and wire seals for electric vehicle (EV) battery packs, EV battery, control units in EVs, e.g., in motor control unit (MCU) devices, lamp housings, fuse boxes, air filters, waterproof connectors, air conditioners, lighting devices, electronic components, Other applications include external waterproofing applications and in equipment designed for drip/trickle irrigation applications (e.g., a micro-irrigation system allowing water and nutrients to drip slowly to the roots of plants, either from above the soil surface or buried below the surface).

The following examples are intended to illustrate and not to limit the disclosure herein.

### Examples

All viscosities were measured at 25° C. unless otherwise indicated. Viscosities of individual components in the following examples were measured using a Brookfield™ rotational viscometer with spindle LV-4 for viscosities over 15,000 mPa.s (Spindle LV-4 designed for viscosities in the range between 1,000-2,000,000 mPa.s) at an appropriate rpm and using a Brookfield™ rotational viscometer with a cone plate arrangement with cone CP-52 for viscosities up to 15, 000 mPa.s at an appropriate rpm unless otherwise indicated.

All compression set results were undertaken in accordance with industrial standard norm ISO 815-1:2019 method A in which a cylindrical disc of diameter 29.0 mm±0.5 mm and thickness 12.5 mm±0.5 mm was compressed by 25% to about 9.38 mm thickness. Under compression the LSR buttons (cured before at 175° C. for 10 min) were kept between two metal plates in a convection oven for a suitable period of time, typically 22 hours at an elevated temperature before compression was released and the test pieces were allowed to recover to a thickness as close to the starting thickness allowing for the compression set to be determined.

A series of compositions were prepared using a 2-part liquid silicone rubber elastomer compositions (Elas. 1-3) as depicted in Table 1 as the standard starting compositions

TABLE 1
2-part liquid silicone rubber (LSR) elastomer compositions (Elas. 1-3)

| | Elas. 1 | Elas. 1 | Elas. 2 | Elas. 2 | Elas. 3 | Elas. 3 |
|---|---|---|---|---|---|---|
| Ingredients | Part (A) | Part (B) | Part (A) | Part (B) | Part (A) | Part (B) |
| Masterbatch 1 | 34.72 | 33.40 | 34.51 | 33.20 | 20.09 | 19.48 |
| Masterbatch 2 | 58.03 | 58.85 | 57.68 | 58.50 | 70.15 | 67.17 |
| Polymer 1 | | | | | 0.95 | 0.56 |
| Polymer 2 | 6.77 | 4.44 | 6.73 | 4.41 | 5.74 | 6.51 |
| Karstedt's | 0.35 | | 0.35 | | 0.35 | |
| catalyst | | | | | | |
| Cross-linker 1 | | 3.22 | | 3.20 | | 3.55 |
| Mold Release Agent | | | 0.6 | 0.6 | 0.59 | 0.59 |
| cyclotetrasiloxane | 0.13 | | 0.13 | | 0.13 | |
| ethynyl | | 0.09 | | 0.09 | | 0.09 |
| cyclohexanol | | | | | | |
| (ETCH) | | | | | | |
| Phenylmethyl | | | | | 2.0 | 2.0 |
| siloxane | | | | | | |
| copolymer | | | | | | |
| CDA-6 | | | | | | 0.05 |

For the avoidance of doubt, in the examples herein the composition was prepared with component (e) added during or after the relevant part (A) composition and part (B) composition had been mixed together. Hence, in Ex. 1 and 2 and C. 1 and 2 where 0.1 wt. % of a compression set additive was introduced the final mixture cured was a combination of 49.95% part (A), as defined in Table 1 above, 49.95% part (B), as defined in Table 1 above together with 0.1 wt. % of the compression set additive.

Analogously in Example 5 in which 0.2 wt. % of CS. 2 is used as the compression set additive, the final mixture cured was a combination of 49.90% part (A), as defined in Table 1 above, 49.90% part (B), as defined in Table 1 above together with 0.2 wt. % of the compression set additive.

In the above compositions:

Masterbatch 1: Masterbatch 1 contains:
70.8 parts by weight of a dimethylvinylsiloxy terminated polydimethylsiloxane having a viscosity of about 53,000 mPa.s at 25° C. measured using a Brookfield™ rotational viscometer with spindle LV-4 at 6 rpm, and
22.4 parts by weight of a fumed silica filler having a surface area of approximately 300 m²/g. The silica is hydrophobized and contains no vinyl functionalization;

Masterbatch 2: Masterbatch 2 contains:
66.6 parts by weight of a dimethylvinylsiloxy terminated polydimethylsiloxane having a viscosity of about 53,000 mPa.s at 25° C. measured using a Brookfield™ rotational viscometer with spindle LV-4 at 6rpm, and
25.8 parts by weight of a fumed silica filler having a surface area of approximately 300 m²/g. The silica is hydrophobized and has a vinyl functionalization of approximately 0.178 mmol/g.

The parts by weight values given are not percentage values and therefore do not need to add to 100.

Polymer 1: polymer 1 is a vinyldimethyl terminated polydimethylsiloxane having a viscosity of 53,000 mPa.s at 25° C. measured using a Brookfield™M rotational viscometer with spindle LV-4 at 6rpm,

Polymer 2: polymer 2 is a vinyl terminal poly(dimethylsiloxane-co-methylvinylsiloxane) having a viscosity of 370 mPa.s at 25° C. using a Brookfield™M rotational viscometer with a cone plate arrangement with cone CP-52 at 12 rpm,

Cross-linker 1: Cross-linker 1 was a trimethyl terminated polymethylhydrogen dimethylsiloxane having a viscosity of 30 mPa.s at 25° C. using a Brookfield™ rotational viscometer with a cone plate arrangement with cone CP-52 at 12 rpm,

Mold release Agent: The mold release agent was a hydroxydimethyl terminated polydimethylsiloxane having viscosity of approximately 21 mPa.s at 25° C. measured using a

Brookfield™ rotational viscometer with spindle LV-2 at 12 rpm,

Cyclotetrasiloxane: The cyclotetrasiloxane was tetravinyl-tetramethyl-cyclotetrasiloxane.

Phenylmethyl siloxane copolymer: the phenylmethyl siloxane copolymer was Trimethylsilyl terminated phenylmethylsiloxane dimethylsiloxane copolymer having a viscosity of 125 mPa.s at 25° C. using a Brookfield™M rotational viscometer with a cone plate arrangement with cone CP-52 at 12 rpm, C

DA 6: CDA 6 was dodecanedioyl-di-(N′-salicyloyl)hydrazine, a synonym for which is 1-N′,12-N′-bis(2-hydroxybenzoyl)dodecanedihydrazide, which is sold commercially as ADK STAB™ CDA-6 from Adeka Corporation.

In use the part (A) and part (B) compositions were mixed together in a 1:1 weight ratio. The resulting composition was inserted into a suitable mold and cured as a button having a thickness of 12.5 mm thickness and a diameter of 29 mm at 175° C. for a period of 10 minutes. Unless otherwise indicated, the resulting silicone rubber was not post-cured. Post-cured samples were post-cured for 4 hours at 200° C. Unless otherwise indicated all the compression set results that follow were determined in accordance with International Organization for Standardization (ISO) Test 815-1:2019 method A.

### Addition of Compression Set Additive to Elas. 1 LSR Composition of Table 1

An assessment was made in respect to the compression set of cured samples of Elas. 1 after compression (comprⁿ) at several alternative temperatures for a period of 22 hours.

Ref. 1 provides the compression set value generated when the composition of Elas. 1 contained no compression set additive(s) and was not post-cured. Ref. 1+PC are samples which were identical to those in Ref. 1 but where said samples were cured and then underwent post-cure. Examples 1 and 2 and comparatives 1 and 2 show compression set results for elastomers resulting from Elas. 1 compositions having contained 0.1 wt. % of a compression set additive present.

After cure (and post-cure where undertaken) the samples were compressed and heated for 22 hours in an oven at 125° C., 150° C., 175° C., 200° C. or 225° C. The compression on each sample was released after removed from oven and allowed to cool for 30 minutes before the respective compression set value was determined. The results are provided in Table 2 below.

TABLE 2
Elas. 1 samples compressed for 22 hours at various temperatures and analysed
for compression set (CST) (%) in accordance with ISO 815-1:2019 method A

| | | CST | CST | CST | CST | CST |
|---|---|---|---|---|---|---|
| | | after | after | after | after | after |
| | | comprⁿ at | comprⁿ at | comprⁿ at | comprⁿ at | comprⁿ at |
| | | 125° C. | 150° C. | 175° C. | 200° C. | 225° C. |
| Ref. 1 | | 8.5 | 24.0 | 55.2 | 69.4 | 76.3 |
| Ref. 1 + PC | | 3.0 | 4.3 | 5.5 | 11.2 | 31.8 |
| Ex. 1 | CS. 1 | 2.7 | 6.5 | 11.8 | 23.3 | 34.5 |
| Ex. 2 | CS. 2 | 4.6 | 5.2 | 12.0 | 21.5 | 34.5 |
| C. 1 | CDA-1 | 3.6 | 5.9 | 12.3 | 37.9 | 84.5 |
| C. 2 | CDA-6 | 8.6 | 10.5 | 15.2 | 22.5 | 48.2 |

CDA 1 was 3-(n-Salicyloyl)Amino-1,2,4-Triazole, a synonym for which is 2-Hydroxy-N-1H-1,2,4-triazol-3-ylbenzamide which is sold commercially as ADK STABTM CDA-1 from Adeka Corporation.

CS. 1 was C—(CH₂OC(═O)—CH₂CH₂—S—(C₁₂H₂₅))₄, pentaerythritol-tetrakis-(3-dodecyl-thio-propionate). CS. 2 was (C₁₂H₂₅)—O—C(═O)—CH₂CH₂—S—CH₂CH₂—C(═O)—O—(C₁₂H₂₅), Didodecyl 3,3′-thiodipropionate.

The Ref. Elas. 1 results for each temperature are effectively the expected maximum compression set values at each temperature after compression for 22 hours. The post cure Elas. 1 results are approximately the minimum compression set value for the temperatures concerned after compression for 22 hours, although a longer post cure period may lower the compression set value a little further. The results using CS. 1 and CS. 2 provided excellent compression set values after 22 hours of compression across all temperatures whereas the commercially used compression set additives CDA-1 and CDA-6 initial compression over the whole temperature range were far less consistent.

A further series of tests were undertaken repeating the previous examples, having 0.1 wt. % of compression set additive added, at the different temperatures but maintaining compression for a period of 168 hours instead of 22 hours. The results are provided in the following Table. 3

TABLE 3
Elas. 1 samples compressed for 168 hours at various temperatures and analysed
for compression set (CST) (%) in accordance with ISO 815-1:2019 method A

| | | CST after | CST after | CST after | CST after | CST after |
|---|---|---|---|---|---|---|
| | | compression | compression | compression | compression | compression |
| | | at 125° C. | at 150° C. | at 175° C. | at 200° C. | at 225° C. |
| Ref. 1 | | 24.4 | 49.3 | 63.0 | 82.1 | 105.4 |
| Ref. 1 + PC | | 6.1 | 10.3 | 21.7 | 45.1 | 95.6 |
| Ex. 3 | CS. 1 | 7.5 | 12.3 | 28.2 | 76.1 | 99.7 |
| Ex. 4 | CS. 2 | 10.2 | 15.0 | 30.6 | 71.7 | 102.1 |
| C. 3 | CDA-1 | 9.3 | 17.9 | 43.1 | 76.8 | 104.4 |
| C. 4 | CDA-6 | 13.0 | 20.7 | 31.7 | 58.4 | 94.8 |

For the avoidance of whilst the theoretical maximum compression set is 100%, compression set values may go above 100% as indicated in Table 2 above. Values of 100% and higher indicate complete compression set loss and additionally thermal shrink effects on the compressed elastomer concerned.

The Ex. 3 and Ex. 4 results gave excellent compression set results after having been compressed for the 168-hour at temperatures below 200° C. when compared with C. 3 and C. 4 but did not show stability of compression set at temperatures of 200° C. and above (225° C.). This indicated that the use of compression set additives CS. 1 and CS. 2 were overall better than the CDA. 1 and CDA. 6 additives up to a compression temperature of about 190° C. This indicated that the compression set improved when using CS. 1 and CS. 2 up to temperatures of about 190° C. compared with CDA-1 and CDA-6. Thus, compounds identified as component (c) are proven to be more consistently good as compression set additives for compression set situations at temperatures of from about 120° C. to about 190° C.

It was found that the addition of at least one thio-propionate in accordance with component (e) of the composition herein, namely CS. 1 or CS. 2 into the compositions results in the resulting cured material having a noticeably lower compression set after 22 hours compression at up to 175° C. Compression set after compression at 200° C. was recognised but was comparatively less substantial.

### Addition of Compression Set Additive to Elas. 2 LSR Composition of Table 1

In a second series of examples, Ref. 2 was the compression set for the cured elastomer resulting from curing the Elas. 2 LSR composition as described in Table 1 with no compression set additive present.

In C. 5 0.1 wt. % of CDA-6 was added as a comparative compression set additive;

In Ex. 5 0.2 wt. % of CS-2, was added as a compression set additive resulting in Ex. 5 only having

CS. 2 as a compression set additive. The compression set results for the different elastomers made from the compositions identified are depicted in Table 4 below.

TABLE 4
Addition of Compression Set additives
to Elas. 2 LSR Composition of Table 1

| | | Compression Set | Compression Set |
|---|---|---|---|
| | | (%) - after 175° C. | (%) - after 200° C. |
| | Additive | for 22 hours | for 22 hours |
| Ref. 2 | | 56.5 | 65.3 |
| C. 5 | CDA 6 | 15.3 | 27.0 |
| Ex. 5 | CS. 2 (0.2 wt. %) | 12.9 | 37.5 |

It can be seen that the presence of the mold release agent in Ex. 5 does not affect the impact of CS. 2 on the compression set results of Ex. 5 after compression at 175° C. for 22 hours compared to CDA 6. However, Ex. 5 gave poorer results than C. 5 (which relied upon CDA 6) at the higher temperature of 200° C. This implies that the compression set of cured silicone elastomers of Ex. 5 are again much improved after 22 hours compression at up to 175° C. when utilising at least one thio-propionate in accordance with component (e) of the composition herein, namely CS. 2 in this instance rather than CDA1 and CDA 6.

### Addition of Compression Set Additive CS. 1 to Elas. 3 LSR Composition of Table 1

In a third series of examples a general purpose LSR, Elas. 3 was used. It contained 0.025 wt. % of CDA 6 when components A and B were mixed together, having 0.05 wt. % of CDA 6 present in the part (B) composition before mixing. Hence, comparative example 6 (C. 6) tested the compression set of Elas. 3 alone (containing 0.025 wt. % of CDA 6). In Ex. 6 Elas. 3 was assessed with an additional 0.1 wt. % of CS. 1. Hence, Ex. 6 contained 0.025 wt. % of CDA-6 and 0.1 wt. % of CS. 1. The results are provided in Table 5 below.

TABLE 5
Addition of Compression Set additives to Elas. 3 LSR Composition
(originally containing 0.025 wt. % of CDA 6) of Table 1

| | | Compression Set | Compression Set |
|---|---|---|---|
| | | (%) - after 175° C. | (%) - after 200° C. |
| | Additive | for 22 hours | for 22 hours |
| C. 6 | | 24.2 | 36.0 |
| Ex. 6 | CS. 1 | 8.5 | 17.5 |

Ex. 6 shows a further improvement on compression set when CS. 1 is added to the Elas. 3 composition at a level of 0.1 wt. % in addition to the CDA 6. It can be seen that the addition of a low amount of tetrakis-dodecyl-thio-propionate significantly reduces compression set of the cured product of the Elas. 3 composition after compression at 175° C. for 22 hours. The combination of CDA 6 and CS. 1 also had a significant effect on compression set after compression for 22 hours at 200° C.

### Addition of Further Compression Set Additive to Elas. 3 LSR Composition of Table 1

In a further series of examples, the general purpose LSR, Elas. 3 was again used. In comparative 7 (C. 7) the composition used was Elas. 3 in combination with 0.3 wt. % CDA 6 (i.e., a total of 0.325 wt. % CDA 6 in the composition when parts A and B were mixed together).

In Ex. 7 the composition used was the same as C. 7 together with 0.1 wt. % CS. 1; and in

Ex. 8 the composition used was the same as C. 7 together with 0.3 wt. % CS. 1;

TABLE 6
Addition of Compression Set additives to Elas. 3 LSR Composition
(originally containing 0.025 wt. % of CDA 6) of Table 1

| | | Compression Set | Compression Set |
|---|---|---|---|
| | | (%) - after 175° C. | (%) - after 200° C. |
| | Additive | for 22 hours | for 22 hours |
| C. 7 | 0.3 wt. % CDA 6 | 22.8 | 31.1 |
| Ex. 7 | 0.3 wt. % CDA 6 + | 16.6 | 24.5 |
| | 0.1 wt. % CS. 1 | | |
| Ex. 8 | 0.3 wt. % CDA 6 + | 13.7 | 30.3 |
| | 0.3 wt. % CS. 1 | | |

Addition of higher amounts (compared to Tables 4 and 5) of CDA-6 and CS. 1 were not found to improve compression set noticeably further.

The data revealed that the addition of small amounts 0.01-0.3 wt % of thio-(di) propionate(s) noticeably reduce compression set after 22 hours compression at temperatures up to about 190° C.

Hence, it will be seen that silicone elastomer materials incorporating component (e) herein produce consistently good compression set results up to a temperature of about 190° C. with out the need for untaking a period of post cure heating. The silicone elastomeric material is therefore suitable for use in seal parts requiring heat resistance over an extended period of time such as for example when used as automotive seal parts and seal parts for electrical and electronic apparatus.

1. A hydrosilylation curable silicone rubber composition, which comprises the following components:
(a) one or more polyorganosiloxanes containing at least two unsaturated groups, selected from alkenyl groups and alkynyl groups, per molecule and having a viscosity of from
(b) 1000 mPa·s 100,000 mPa·s 25° C.;
(b) an organosilicon compound having at least two, or optionally at least three, Si—H groups per molecule;
(c) a silica reinforcing filler, which is optionally hydrophobically treated;
(d) a hydrosilylation catalyst comprising, or optionally consisting of, a platinum group metal or a compound thereof; and
(e) at least one thio-propionate selected from 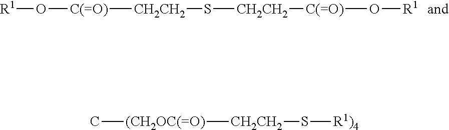
where each R¹ may be the same or different and is an alkyl group, wherein the total wt. % of the composition is 100 wt. %.

2. The hydrosilylation curable silicone rubber composition in accordance with claim 1, wherein component (e) is present in an amount of from 0.025 to 0.5 wt. % of the composition.

3. The hydrosilylation curable silicone rubber composition in accordance with claim 1, wherein component (e) is present in an amount of from 0.05 to 0.35 wt. % of the composition.

4. The hydrosilylation curable silicone rubber composition in accordance with claim 1, wherein in component (e) each R¹ is a linear alkyl group having from 10 to 25 carbons.

5. The hydrosilylation curable silicone rubber composition in accordance with claim 1, wherein component (e) comprises one or more of didodecyl 3,3′-thiodipropionate, di(tridecyl) 3,3′-thiodipropionate, dioctadecyl 3,3′-thiodipropionate and pentaerythritol-tetrakis-(3-dodecyl-thio-propionate).

6. The hydrosilylation curable silicone rubber composition in accordance with claim 1, wherein the composition is stored before use in two parts, Part (A) and Part (B), to keep components (b) and (d) apart to avoid premature cure.

7. The hydrosilylation curable silicone rubber composition in accordance with claim 6, wherein component (e) is present in Part (A), Part (B), or a combination of Parts (A) and (B) of the composition or is added to the combination of Parts (A) and (B) during or after mixing Parts (A) and (B) together.

8. The hydrosilylation curable silicone rubber composition in accordance with claim 1, which also comprises one or more additives selected from cure inhibitors, blowing agents, mold releasing agents, adhesion catalysts, peroxides, electrically conductive fillers, thermally conductive fillers, pot life extenders, flame retardants, lubricants, heat stabilisers, UV light stabilizers, bactericides and/or wetting agents.

9. A silicone elastomeric material, which is the cured product of the hydrosilylation curable silicone rubber composition in accordance with claim 1.

10. The silicone elastomeric material in accordance with claim 9, which has a compression set of 25% or less, or optionally 20%, after compression for 22 hours at 175° C. when measured in accordance with industrial standard ISO 815-1:2019 method A and/or of 40% or less, after compression for 168 hours at 175° C. when measured in accordance with industrial standard ISO 815-1:2019 method A.

11. A process for making a silicone elastomeric material, the process comprising the steps of mixing the hydrosilylation curable silicone rubber composition in accordance with claim 1; and curing the hydrosilylation curable silicone rubber composition at a temperature of from 80° C. to 200° C.

12. A silicone elastomeric material, obtained or obtainable from a process comprising the steps of mixing the hydrosilylation curable silicone rubber composition in accordance with claim 1; and curing the hydrosilylation curable silicone rubber composition at a temperature of from 80° C. to 200° C., which has a compression set of 25% or less, or optionally 20%, after compression for 22 hours at 175° C. when measured in accordance with industrial standard ISO 815-1:2019 method A and/or of 40% or less, after compression for 168 hours at 175° C. when measured in accordance with industrial standard ISO 815-1:2019 method A.

13. The hydrosilylation curable silicone rubber composition in accordance with claim 1, wherein component (e) comprises:

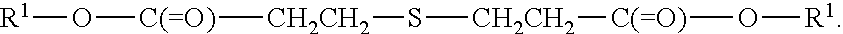

14. The hydrosilylation curable silicone rubber composition in accordance with claim 1, wherein component (e) comprises: C—(CH₂OC(═O)—CH₂CH₂—S—R¹)₄.

15. The hydrosilylation curable silicone elastomeric material in accordance with claim 9, suitable for use as and/or in at least one of silicone coatings for non-silicone insulators, cable coatings for electrical connectors, terminations and wire seals, heat dissipation parts for broadband cellular networks, and communication electronics devices.
